(19) United States
(12) Patent Application Publication
(10) Pub. No.: US 2021/0256601 A1
(43) Pub. Date: Aug. 19, 2021

(54) APPARATUSES, SYSTEMS AND METHODS FOR DETERMINING PRE-APPROVAL FOR PERIODIC OBLIGATION SATISFACTIONS BASED ON UNEVEN OR SEASONAL INCOME

(71) Applicant: STATE FARM MUTUAL AUTOMOBILE INSURANCE COMPANY, Bloomington, IL (US)

(72) Inventors: Jacob J. Alt, Downs, IL (US); Jessica Lynn Shull, Bloomington, IL (US); Joseph Robert Brannan, Bloomington, IL (US); Daryoush Hakimi, Bloomington, IL (US)

(21) Appl. No.: 15/890,966

(22) Filed: Feb. 7, 2018

Related U.S. Application Data
(60) Provisional application No. 62/512,225, filed on May 30, 2017.
(60) Provisional application No. 62/491,710, filed on Apr. 28, 2017.

(51) Int. Cl. G06Q 40/02; G06Q 20/10; G06Q 20/14; G06Q 20/02

(52) U.S. Cl. CPC G06Q 40/025; G06Q 20/02; G06Q 20/14; G06Q 20/102

(57) ABSTRACT

Systems and methods may provide for customer pre-approval for a flexible loan product that may dynamically change to account for uneven or seasonal income of a customer. Some flexible loan products may include loan, warranty, and/or insurance payments. Past and/or current customer data, such as past and current income, predicted future income, current home or vehicle value, current interest rates, and/or vehicle or home maintenance, may be analyzed by artificial intelligence to periodically reassess and restructure the future loan payments.

### CROSS REFERENCE TO RELATED APPLICATION

This application claims priority, under 35 U.S.C. § 119(b), to U.S. Provisional Patent Application Ser. No. 62/491,710, filed on Apr. 28, 2017, and entitled APPARATUSES, SYSTEMS AND METHODS FOR DETERMINING PERIODIC OBLIGATION SATISFACTIONS BASED ON PERSONAL FINANCES, and U.S. Provisional Patent Application Ser. No. 62/512,225, filed on May 30, 2017, and entitled APPARATUSES, SYSTEMS AND METHODS FOR DETERMINING PERIODIC OBLIGATION SATISFACTIONS BASED ON PERSONAL FINANCES the entire disclosures of which are incorporated herein by reference.

### TECHNICAL FIELD

The present disclosure relates to determining periodic loan payments. In particularly, the present disclosure relates to determining periodic loan payments based upon client income receipt dates.

### BACKGROUND

Historically, loan payments (e.g., vehicle loan payments, mortgage loan payments, etc.) have been structured to include a monthly payment schedule with a fixed monthly payment amount. While known variable interest loans may result in loan payment amounts that periodically change, the loan payments are still structured to include a monthly payment schedule.

Traditionally, most individuals were employed with a periodic (e.g., weekly, bi-weekly, monthly, etc.) income having a fixed amount. Modern employment (e.g., self-employment, contract employment, piece-work, commission based employment, etc.), on the other hand, often results in incomes having wildly diverging amounts and receipt schedules. Conventional loan products may be tailored toward individuals that receive periodic income payments, leading to conventional loan products having various drawbacks.

### SUMMARY

The present embodiments relate to determining periodic obligation satisfactions (e.g., loan payments, warranty payments, insurance payments, any combination thereof, any sub-combination thereof, etc.) that are based upon client income receipt dates. The present embodiments may also relate to determining periodic obligation satisfactions (e.g., loan payments, warranty payments, insurance payments, any combination thereof, any sub-combination thereof, etc.) that are based upon client variable income amounts.

One aspect of the present embodiments relates to flexible or adjustable loan payments based upon a varying income of an individual. For instance, an obligation satisfaction system may include a client income data receiving module stored on a memory that, when executed by a processor, causes the processor to receive client income data. The client income data may be representative of client income amounts and client income receipt dates. The obligation satisfaction system may also include a client obligation satisfaction generation module stored on a memory that, when executed by a processor, causes the processor to generate a client obligation satisfaction schedule based upon the client income data. The client obligation satisfaction schedule may be representative of payment due dates that are correlated with the client income receipt dates. The system may include additional, less, or alternate functionality, including that discussed elsewhere herein.

In another aspect, a tangible computer-readable medium including computer-readable instructions stored thereon that, when executed by a processor, may cause the processor to implement an obligation satisfaction system. The tangible computer-readable medium may include a client income data receiving module that, when executed by a processor, causes the processor to receive client income data from a client device and/or a third-party computing device. The client income data may be representative of client income receipt dates. The tangible computer-readable medium may also include a client obligation satisfaction generation module that, when executed by a processor, causes the processor to generate a client obligation satisfaction schedule based upon the client income data. The client obligation satisfaction schedule may be representative of payment due dates that are correlated with the client income receipt dates. The instructions may direct the processor to perform additional, less, or alternate functionality, including that discussed elsewhere herein.

In a further aspect, a computer-implemented obligation satisfaction method may include receiving, at a processor, client income data, from a client device and/or a third-party computing device, in response to the processor executing a client income data receiving module. The client income data may be representative of client income receipt dates. The method may also include generating, using a processor, a client obligation satisfaction schedule based upon the client income data, in response to the processor executing a client obligation satisfaction generation module. The client obligation satisfaction schedule may be representative of payment due dates that are correlated with the client income receipt dates. The method may include additional, less, or alternate actions, including those discussed elsewhere herein.

In another aspect, the present embodiments may relate to bundling loan and insurance payments. For instance, a combination loan and insurance payment system may include a client income data receiving module stored on a memory that, when executed by a processor, causes the processor to receive client income data. The client income data may be representative of client income amounts and client income receipt dates. The system may also include a client insurance data receiving module stored on a memory that, when executed by a processor, causes the processor to receive client insurance data. The client insurance data may be representative of client insurance charges. The system may further include a client loan and insurance payment generation module stored on a memory that, when executed by a processor, causes the processor to generate a client loan and insurance payment schedule based upon the client income data and the client insurance data. The client loan and insurance payment schedule may be representative of payment due dates that are correlated with the client income receipt dates. The system may include additional, less, or alternate functionality, including that discussed elsewhere herein.

In a further aspect, a tangible computer-readable medium including computer-readable instructions stored thereon that, when executed by a processor, may cause the processor to implement a combination loan and insurance payment system. The tangible computer-readable medium may include a client income data receiving module that, when executed by a processor, causes the processor to receive client income data from a client device and/or a third-party computing device. The client income data may be representative of client income receipt dates. The tangible computer-readable medium may also include a client insurance data receiving module that, when executed by a processor, causes the processor to receive client insurance data. The client insurance data may be representative of client insurance charges. The tangible computer-readable medium may further include a client loan and insurance payment generation module that, when executed by a processor, causes the processor to generate a client loan and insurance payment schedule based upon the client income data and the client insurance data. The client combination loan and insurance payment schedule may be representative of payment due dates that are correlated with the client income receipt dates. The instructions may direct additional, less, or alternate functionality, including that discussed elsewhere herein.

In another aspect, a computer-implemented combination loan and insurance payment method may include receiving, at a processor, client income data, from a client device and/or a third-party computing device, in response to the processor executing a client income data receiving module. The client income data may be representative of client income receipt dates. The method may also include receiving, at a processor, client insurance data, from an insurance provider computing device, in response to the processor executing a client insurance data receiving module. The client insurance data may be representative of client insurance charges. The method may further include generating, using a processor, a client combination loan and insurance payment schedule based upon the client income data and the client insurance data, in response to the processor executing a client combination loan and insurance payment generation module. The client combination loan and insurance payment schedule may be representative of payment due dates that are correlated with the client income receipt dates. The method may include additional, less, or alternate actions, including those discussed elsewhere herein.

In a further aspect, the present embodiments may include periodic reassessment and/or restructuring of future loan payments based upon past and/or current data (e.g., past income, predicted future income, past payments, current vehicle value, current interest rates, past vehicle maintenance, etc.). A dynamic obligation satisfaction system may include a client past income data receiving module stored on a memory that, when executed by a processor, causes the processor to receive client past income data. The client past income data may be representative of client past income amounts and client past income receipt dates. The system may also include a client predicted income data receiving module stored on a memory that, when executed by a processor, causes the processor to receive client predicted income data. The client predicted income data may be representative of client predicted income amounts and client predicted income receipt dates. The system may further include a client obligation satisfaction generation module stored on a memory that, when executed by a processor, causes the processor to dynamically generate a client obligation satisfaction schedule based upon the client past income data and the client predicted income data. The client obligation satisfaction schedule may be representative of payment due dates that are correlated with the client income receipt dates. The system may include additional, less, or alternate functionality, including that discussed elsewhere herein.

In another aspect, a tangible computer-readable medium including computer-readable instructions stored thereon that, when executed by a processor, may cause the processor to implement a dynamic obligation satisfaction system. The tangible computer-readable medium may include a client past income data receiving module that, when executed by a processor, causes the processor to receive client past income data. The client past income data may be representative of client past income receipt dates. The tangible computer-readable medium may also include a client predicted income data receiving module that, when executed by a processor, causes the processor to receive client predicted income data. The client predicted income data is representative of client predicted income receipt dates. The tangible computer-readable medium may further include a client obligation satisfaction generation module stored on a memory that, when executed by a processor, causes the processor to dynamically generate a client obligation satisfaction schedule based upon the client past income data and the client predicted income data. The client obligation satisfaction schedule may be representative of payment due dates that are correlated with the client past income receipt dates and the client predicted income receipt data. The instructions may direct additional, less, or alternate functionality, including that discussed elsewhere herein.

In a further aspect, a computer-implemented dynamic obligation satisfaction method may include receiving, at a processor, client past income data, from a client device and/or a third-party computing device, in response to the processor executing a client past income data receiving module. The client past income data may be representative of client past income receipt dates. The method may also include receiving, at a processor, client predicted income data, from a client device and/or a third-party computing device, in response to the processor executing a client predicted income data receiving module. The client predicted income data may be representative of client predicted income receipt dates. The method may further include generating, using a processor, a dynamic client obligation satisfaction schedule based upon the past client income data and the predicted client income data, in response to the processor executing a client dynamic obligation satisfaction generation module. The client dynamic obligation satisfaction schedule may be representative of payment due dates that are correlated with the client past income receipt dates and the client predicted income receipt dates. The method may include additional, less, or alternate actions, including those discussed elsewhere herein.

In another aspect, an obligation satisfaction system may include a third-party data generation module stored on a memory that, when executed by a processor, causes the processor to generate client pre-approval data based upon at least one of: client data, client income data, client loan and credit historical payment data, credit utilization data, length of client pre-existing loan and credit data, credit and loan mix data, or client new loan and new credit data. The client pre-approval data may be representative of whether an individual is suitable for enrollment for periodic obligation satisfaction. The system may also include a client obligation satisfaction generation module stored on a memory that, when executed by a processor, causes the processor to generate a client obligation satisfaction schedule based upon the client income data and the client pre-approval data. The client obligation satisfaction schedule may be representative of at least one of: payment due dates that are correlated with client income receipt dates, client loan and insurance payments that are correlated with client income receipt dates, or dynamically determined payment due dates that are correlated with client income receipt dates.

In a further aspect, a tangible computer-readable medium including computer-readable instructions stored thereon that, when executed by a processor, may cause the processor to implement an obligation satisfaction system. The tangible computer-readable medium may include a third-party data generation module that, when executed by a processor, causes the processor to generate client pre-approval data based upon at least one of: client data, client income data, client loan and credit historical payment data, credit utilization data, length of client pre-existing loan and credit data, credit and loan mix data, or client new loan and new credit data. The client pre-approval data may be representative of whether an individual is suitable for enrollment for periodic obligation satisfaction. The tangible computer-readable medium may further include a client obligation satisfaction generation module that, when executed by a processor, causes the processor to generate a client obligation satisfaction schedule based upon the client income data and the client pre-approval data. The client obligation satisfaction schedule is representative of at least one of: payment due dates that are correlated with client income receipt dates, client loan and insurance payments that are correlated with client income receipt dates, or dynamically determined payment due dates that are correlated with client income receipt dates.

In another aspect, a computer-implemented obligation satisfaction method may include generating, using a processor of a computing device, client pre-approval data that is based upon at least one of: client data, client income data, client loan and credit historical payment data, credit utilization data, length of client pre-existing loan and credit data, credit and loan mix data, or client new loan and new credit data. The client pre-approval data may be representative of whether an individual is suitable for enrollment for periodic obligation satisfaction. The method may further include generating, using a processor of a computing device, a client obligation satisfaction schedule based upon the client income data and the client pre-approval data. The client obligation satisfaction schedule is representative of at least one of: payment due dates that are correlated with client income receipt dates, client loan and insurance payments that are correlated with client income receipt dates, or dynamically determined payment due dates that are correlated with client income receipt dates.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of computer-implemented methods, systems comprising computer-readable media, and electronic devices disclosed therein. It should be understood that each Figure depicts an embodiment of a particular aspect of the disclosed methods, media, and devices, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 depicts a block diagram of an exemplary computer system for determining periodic obligation satisfactions (e.g., loan payments, warranty payments, insurance payments, any combination thereof, any sub-combination thereof, etc.) based upon client income receipt dates;

FIG. 2 depicts a block diagram of an exemplary client device for use within the exemplary computer system of FIG. 1;

FIG. 3 depicts an exemplary computer-implemented method of operation of the exemplary client device of FIG. 2;

FIG. 4 depicts a block diagram of an exemplary lender device for use within the exemplary computer system of FIG. 1;

FIG. 5 depicts an exemplary computer-implemented method of operation of the exemplary lender device of FIG. 4;

FIG. 6 depicts a block diagram of an exemplary government computing device for use within the exemplary computer system of FIG. 1;

FIG. 7 depicts an exemplary computer-implemented method of operation of the exemplary government computing device of FIG. 6;

FIG. 8 depicts a block diagram of an exemplary real estate appraisal computing device for use within the exemplary computer system of FIG. 1;

FIG. 9 depicts an exemplary computer-implemented method of operation of the exemplary real estate appraisal computing device of FIG. 8;

FIG. 10 depicts a block diagram of an exemplary third-party computing device for use within the exemplary computer system of FIG. 1;

FIG. 11 depicts an exemplary computer-implemented method of operation of the exemplary third-party computing device of FIG. 10; and

FIG. 12 depicts an exemplary computer-implemented method of determining whether an individual is suitable for enrollment for periodic obligation satisfaction.

The Figures depict aspects of the present invention for purposes of illustration only. One skilled in the art will readily recognize from the following discussion that alternate aspects of the structures and methods illustrated herein may be employed without departing from the principles of the invention described herein.

### DETAIL DESCRIPTION

Apparatuses, systems and methods are provided for determining periodic obligation satisfactions (e.g., loan payments, warranty payments, insurance payments, any combination thereof, any sub-combination thereof, etc.) based upon client income receipt dates. Obligation satisfactions (e.g., loan payments, warranty payments, insurance payments, any combination thereof, any sub-combination thereof, etc.) may be further based upon client income amounts, lender data, government data, third-party data and/or real estate appraisal data.

The client data may be, for example, representative of personal information (e.g., name, age, gender, address, social security number, marital status/spouse, employment/income, etc.) and/or income records (e.g., bank deposits, employer, self-employment contracts, paycheck subs, etc.). The client data may also be representative of home mortgage loan information related to purchase of real estate, such as, transaction detail (e.g., Purchase price, down payment amount, down payment percentage, loan amount), property detail (e.g., property address, how will property be used (e.g., primary residence, investment property, secondary/vacation home, etc.), type of home associated with the mortgage loan (e.g., single-family, two-family, three-family, four-family, condo, townhouse, etc.), state where the property associated with the loan located in, estimated real estate taxes associated with the property, and/or estimated cost of homeowner's insurance and homeowner's association dues. The client data may be further representative of income and expense details (e.g., client's gross total income, client's current liabilities (e.g., credit cards, student loan, etc.), whether borrower is a first time home buyer (FTHB) and/or not owned in the last 3 years).

The client data may be yet further representative of information associated with refinancing a home, obtaining a home equity loan, or obtaining a home equity line of credit, such as, refinance type (e.g., limited cash out, cash out, etc.), value of property being refinance (e.g., current market value, current loan balance, etc.), property detail, property address, how will property be used (e.g., primary residence, investment property, secondary/vacation home, etc.), what kind of home is being refinances (e.g., single-family, two-family, three-family, four-family, condo, townhouse, etc.), state where property being refinanced located, estimated real estate taxes associated with property being refinanced, estimated homeowner's insurance associated with property to be refinanced, and/or homeowner's association dues. The client data may also be representative of client income and expense details, such as, client gross total income, client current liabilities (e.g., credit cards, student loan, etc.), and/or whether the borrower is a FTHB and/or has not owned in the last 3 years.

The client data may also be representative of a vehicle loan (e.g., car, truck, recreational vehicle, all-terrain vehicle (ATV), boat, motorcycle, travel trailer, jet ski, snowmobile, etc.), including a purchase price, a cash rebate, a value of a trade-in, an amount owed on the trade-in, a down payment, a loan term (months), and/or an interest rate.

The lender data may also be representative of home mortgage loan information related to purchase of real estate, such as, transaction detail (e.g., purchase price, down payment amount, down payment percentage, loan amount), property detail (e.g., property address, how will property be used (e.g., primary residence, investment property, secondary/vacation home, etc.), type of home associated with the mortgage loan (e.g., single-family, two-family, three-family, four-family, condo, townhouse, etc.), state where the property associated with the loan located in, estimated real estate taxes associated with the property, estimated cost of homeowner's insurance, homeowner's association dues. The lender data may be further representative of income and expense details (e.g., client's gross total income, client's current liabilities (e.g., credit cards, student loan, etc.), whether the borrower is a FTHB, or has not owned in the last 3 years).

The lender data may be yet further representative of information associated with refinance a home, obtaining a home equity loan, or obtaining a home equity line of credit, such as, refinancing type (e.g., limited cash out, cash out, etc.), value of property being refinance (e.g., current market value, current loan balance, etc.), property detail, property address, how will property be used (e.g., primary residence, investment property, secondary/vacation home, etc.), what kind of home is being refinances (e.g., single-family, two-family, three-family, four-family, condo, townhouse, etc.), state where property being refinanced located, estimated real estate taxes associated with property being refinanced, estimated homeowner's insurance associated with property to be refinanced, and/or homeowner's association dues. The lender data may also be representative of client income and expense details, such as, client gross total income, client current liabilities (e.g., credit cards, student loan, etc.), and/or whether the borrower is a FTHB, and/or has not owned in the last 3 years.

The lender data may also be representative of a vehicle loan (e.g., car, truck, recreational vehicle, all-terrain vehicle (ATV), boat, motorcycle, travel trailer, jet ski, snowmobile, etc.), including a purchase price, a cash rebate, a value of a trade-in, an amount owed on the trade-in, a down payment, a loan term (months), and/or an interest rate.

The government data may be representative of client criminal records (e.g., LexisNexis report, truthfinder.com, instantcheckmate.com, backgroundalert.com, screeningworks.com, local municipality, County, State, Federal, etc.) information, bureau of motor vehicle (BMV) driving records (e.g., client accidents, client vehicle insurance information, etc.) information, and/or real estate records (e.g., County Auditor's Office, Department of Natural Resources, etc.).

The real estate appraisal data may be representative of, for example, an appraised value of real estate, physical condition of real estate, leans placed on real estate, etc.

The third-party data may be representative of income records (e.g., bank deposits, employer, self-employment contracts, paycheck subs, etc.), financial institution (e.g., bank, credit union, brokerage firm, annuity firm, etc.) information, life insurance, and/or payment history. The third-party data may also be representative of credit rating agencies (e.g., VantageScore, Experian, TransUnion, Equifax, etc.) information (e.g., credit score, credit card debt, credit card limits, and/or credit card monthly balance cycle). The third-party data may further be representative of existing loans (e.g., loan holder, amount of loan, when pay off due, payment history, etc.), assets (e.g., real estate, vehicles, savings accounts, stocks, annuities, bonds, etc.), current/past insurance (e.g., LexisNexis report, truthfinder.com, instantcheckmate.com, backgroundalert.com, screeningworks.com, real estate records, vehicle records, life insurance records, health insurance records, dental insurance records, vision insurance records, etc.), a vehicle value (e.g., Kelley Blue Book, NADA Guides, Edmunds, etc.), vehicle maintenance records (e.g., carfax, vehicle original equipment manufacturer, etc.), and/or client income records (e.g., bank deposits, employer, self-employment contracts, paycheck subs, etc.).

### Determining Periodic Obligation Satisfactions Based Upon Client Income Receipt Dates

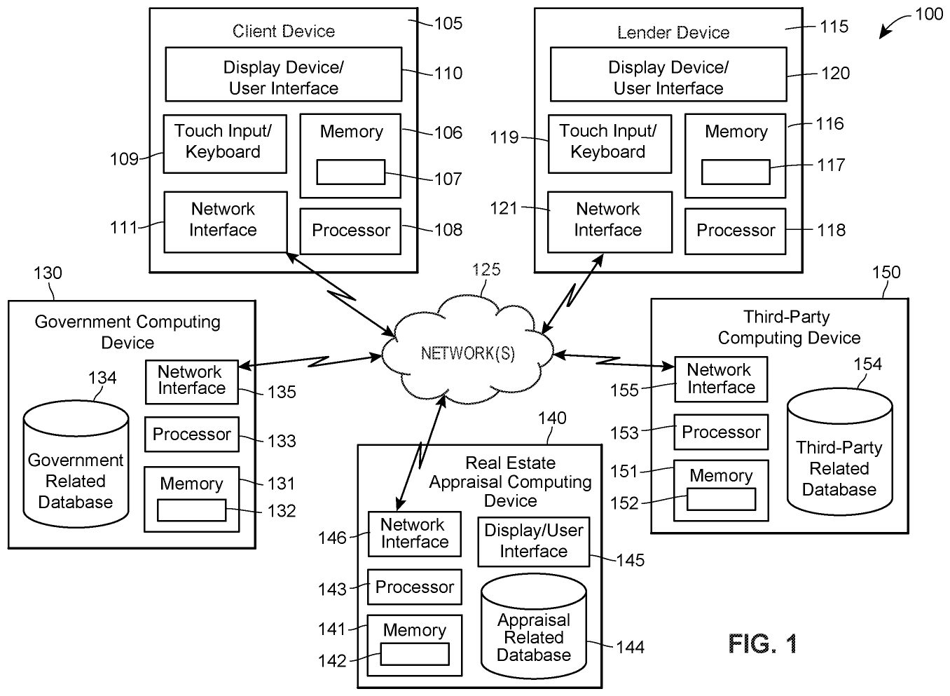

Turning to FIG. 1, a system for determining periodic obligation satisfactions (e.g., loan payments, warranty payments, insurance payments, any combination thereof, any sub-combination thereof, etc.) based upon client income receipt dates 100 may include a client device 105, a lender device 115, a government computing device 130, a real estate appraisal computing device 140, and a third-party computing device 150 communicatively connected to one another via a communications network 125. For clarity, only one client device 105, one lender device 115, one government computing device 130, one real estate appraisal computing device 140, and one third-party computing device 150 are depicted in FIG. 1. While FIG. 1 depicts only one client device 105, one lender device 115, one government computing device 130, one real estate appraisal computing device 140, and one third-party computing device 150, it should be understood that any number of client devices 105, lender devices 115, government computing devices 130, real estate appraisal computing devices 140, and third-party computing devices 150 may be supported.

The client device 105 may include a memory 106 and a processor 108 for storing and executing, respectively, a module 107. The module 107, stored in the memory 106 as a set of computer-readable instructions, may be related to an application for allowing a client to enter personal information and receive information related to a loan that, when executed on the processor 108, may cause the processor 108 to generate a user interface that enables a client to enter client data (e.g., client personal information, client loan request information, client income information, etc.) via, for example, a touch input/keyboard 109, and may cause the client data to be transmitted to, for example, a lender device (e.g., lender device 115), a government computing device (e.g., government computing device 130), a real estate appraisal computing device (e.g., real estate appraisal computing device 140), and/or a third-party computing device (e.g., third-party computing device 150). Execution of the module 107 may also cause the processor 108 to receive loan data from, for example, the lender device 115. Execution of the module 107 may further cause the processor 108 to generate a display based upon the loan data, and present the display via a display device/user interface 110.

The client device 105 may include a network interface 111 configured to facilitate communications between the client device 105, the lender device 115, the government computing device 130, the real estate appraisal computing device 140, and the third-party computing device 150 via any hardwired or wireless communication network 125, including for example a wireless LAN, MAN or WAN, WiFi, a wireless cellular telephone network, an Internet connection, or any combination thereof. Moreover, the client device 105 may be communicatively connected to the lender device 115, the government computing device 130, the real estate appraisal computing device 140, and the third-party computing device 150 via any suitable communication system, such as via any publicly available or privately owned communication network, including those that use wireless communication structures, such as wireless communication networks, including for example, wireless LANs and WANs, satellite and cellular telephone communication systems, etc.

The lender device 115 may include a memory 116 and a processor 118 for storing and executing, respectively, a module 117. The module 117, stored in the memory 116 as a set of computer-readable instructions, facilitates applications related to determining client obligation satisfactions (e.g., loan payments, warranty payments, insurance payments, any combination thereof, any sub-combination thereof, etc.) based upon, for example, client income receipt dates. The processor 118 may execute the module 117 to cause the processor 118 to generate a user interface on the display 120 which may enable a user to enter lender data (e.g., available loan information, interest rates, insurance information, warranty information, etc.) via, for example, a tough input/keyboard 119. Execution of the module 117 may also facilitate communications between the lender device 105, the client device 115, the government computing device 130, the real estate appraisal computing device 140, the third-party computing device 150, and/or the network 125, and other functions and instructions.

The memory 116 of the lender device 115 may also store, for example, a loan information related database, an insurance information related database, and/or a warranty information related database. While the loan information related database, the insurance information related database, and the warranty information related database may be stored in the memory 116 of the lender device 115, it should be understood that the loan information related database, the insurance information related database, and/or the warranty information related database may be located within separate remote servers (or any other suitable computing devices) communicatively coupled to the lender device 115. Optionally, portions of the loan information related database, the insurance information related database, and/or the warranty information related database may be associated with memory modules that are separate from one another, such as a memory 106 of the client device 105, memory 131 of the government computing device 130, memory 141 of the real estate appraisal computing device 140, and/or the memory 151 and/or third-party related database 154 of the third-party computing device 150.

The lender device 115 may include a network interface 121 that may be configured to facilitate communications between the lender device 115 and the client device 115, the government computing device 130, the real estate appraisal computing device 140, and/or the third-party computing device 150 via any hardwired or wireless communication network 125, including for example a wireless LAN, MAN or WAN, WiFi, the Internet, a Bluetooth connection, or any combination thereof. Moreover, the lender device 115 may be communicatively connected to the client device 105, the government computing device 130, the real estate appraisal computing device 140, and/or the third-party computing device 150 via any suitable communication system, such as via any publicly available or privately owned communication network, including those that use wireless communication structures, such as wireless communication networks, including for example, wireless LANs and WANs, satellite and cellular telephone communication systems, etc.

The government computing device 130 may include a memory 131 and a processor 133 for storing and executing, respectively, a module 132. The module 132, stored in the memory 131 as a set of computer-readable instructions, facilitates applications related to determining client obligation satisfactions (e.g., loan payments, warranty payments, insurance payments, any combination thereof, any sub-combination thereof, etc.) based upon, for example, client income receipt dates. The processor 133 may execute the module 132 to cause the processor 133 to facilitate communications between the government computing device 130, the client device 105, the lender device 115, the real estate appraisal computing device 140, the third-party computing device 150, and/or the network 125, and other functions and instructions.

The government computing device 130 may be communicatively connected to, for example, a government related database 134. While the government related database may be communicatively connected to the government computing device 130, it should be understood that the government related database may be located within separate remote servers (or any other suitable computing devices) communicatively coupled to the government computing device 130. Optionally, portions of the government related database 134 may be associated with memory modules that are separate from one another, such as a memory 106 of the client device 105, memory 131 of the government computing device 130, memory 141 of the real estate appraisal computing device 140, and/or the memory 151 and/or third-party related database 154 of the third-party computing device 150.

The government computing device 130 may include a network interface 135 that may be configured to facilitate communications between the government computing device 130 and the client device 115, the lender device 115, the real estate appraisal computing device 140, and/or the third-party computing device 150 via any hardwired or wireless communication network 125, including for example a wireless LAN, MAN or WAN, WiFi, the Internet, a Bluetooth connection, or any combination thereof. Moreover, the government computing device 130 may be communicatively connected to the client device 105, the lender device 115, the real estate appraisal computing device 140, and/or the third-party computing device 150 via any suitable communication system, such as via any publicly available or privately owned communication network, including those that use wireless communication structures, such as wireless communication networks, including for example, wireless LANs and WANs, satellite and cellular telephone communication systems, etc.

The real estate appraisal computing device 140 may include a memory 141 and a processor 143 for storing and executing, respectively, a module 142. The module 142, stored in the memory 141 as a set of computer-readable instructions, facilitates applications related to determining client obligation satisfactions (e.g., loan payments, warranty payments, insurance payments, any combination thereof, any sub-combination thereof, etc.) based upon, for example, client income receipt dates. The processor 143 may execute the module 142 to cause the processor 143 to generate a user interface on the display 145 which may enable a user to enter real estate appraisal data (e.g., an appraised value of real estate, physical condition of real estate, leans placed on real estate, etc.). The processor 143 may execute the module 142 to cause the processor 143 to facilitate communications between the real estate appraisal computing device 140, the client device 105, the lender device 115, the government computing device 130, the third-party computing device 150, and/or the network 125, and other functions and instructions.

The real estate appraisal computing device 140 may be communicatively connected to, for example, a real estate appraisal related database 144. While the real estate appraisal related database may be communicatively connected to the real estate appraisal computing device 140, it should be understood that the real estate appraisal related database may be located within separate remote servers (or any other suitable computing devices) communicatively coupled to the real estate appraisal computing device 140. Optionally, portions of the real estate appraisal related database 144 may be associated with memory modules that are separate from one another, such as a memory 106 of the client device 105, memory 131 of the government computing device 130, and/or the memory 151 and/or third-party related database 154 of the third-party computing device 150.

The real estate appraisal computing device 140 may include a network interface 145 that may be configured to facilitate communications between the real estate appraisal computing device 140 and the client device 115, the lender device 115, the government computing device 130, and/or the third-party computing device 150 via any hardwired or wireless communication network 125, including for example a wireless LAN, MAN or WAN, WiFi, the Internet, a Bluetooth connection, or any combination thereof. Moreover, the real estate appraisal computing device 140 may be communicatively connected to the client device 105, the lender device 115, the government computing device 130, and/or the third-party computing device 150 via any suitable communication system, such as via any publicly available or privately owned communication network, including those that use wireless communication structures, such as wireless communication networks, including for example, wireless LANs and WANs, satellite and cellular telephone communication systems, etc.

The third-party computing device 150 may include a memory 151 and a processor 153 for storing and executing, respectively, a module 152. The module 152, stored in the memory 151 as a set of computer-readable instructions, may facilitate applications related to determining client obligation satisfactions (e.g., loan payments, warranty payments, insurance payments, any combination thereof, any sub-combination thereof, etc.) based upon, for example, client income receipt dates. The processor 153 may execute the module 152 to cause the processor 153 to facilitate communications between the third-party computing device 150, the client device 105, the lender device 115, the real estate appraisal computing device 140, the government computing device 130, and/or the network 125, and other functions and instructions.

The third-party computing device 150 may be communicatively connected to, for example, a third-party related database 154. While the third-party related database may be communicatively connected to the third-party computing device 150, it should be understood that the third-party related database may be located within separate remote servers (or any other suitable computing devices) communicatively coupled to the third-party computing device 150. Optionally, portions of the third-party related database 154 may be associated with memory modules that are separate from one another, such as a memory 106 of the client device 105, memory 131 of the government computing device 130, memory 141 of the real estate appraisal computing device 140, and/or the memory 116 of the lender computing device 115.

The third-party computing device 150 may include a network interface 155 that may be configured to facilitate communications between the third-party computing device 150 and the client device 115, the lender device 115, the real estate appraisal computing device 140, and/or the government computing device 130 via any hardwired or wireless communication network 125, including for example a wireless LAN, MAN or WAN, WiFi, the Internet, a Bluetooth connection, or any combination thereof. Moreover, the third-party computing device 150 may be communicatively connected to the client device 105, the lender device 115, the real estate appraisal computing device 140, and/or the lender device 115 via any suitable communication system, such as via any publicly available or privately owned communication network, including those that use wireless communication structures, such as wireless communication networks, including for example, wireless LANs and WANs, satellite and cellular telephone communication systems, etc.

Client Device for Use within a System for Determining Periodic Obligation Satisfactions Based Upon Client Income Receipt Dates

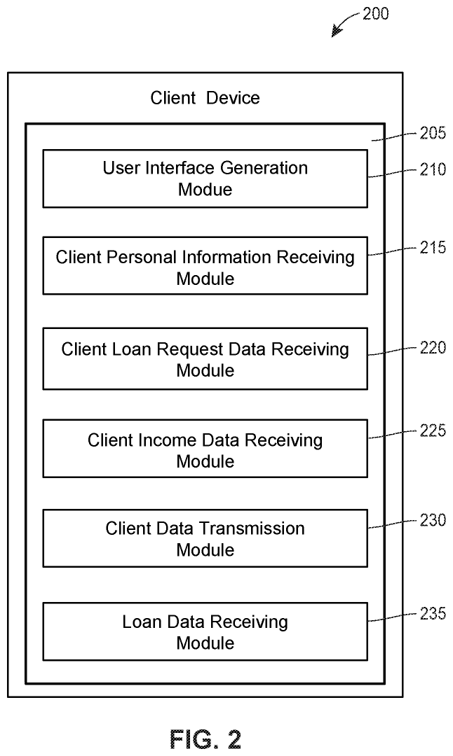

With reference to FIG. 2, a client device 200 may include a user interface generation module 210, a client personal information receiving module 215, a client loan request data receiving module 220, a client income data receiving module 225, a client data transmission module 230, and a loan data receiving module 235 stored on a memory 205. The client device 200 may be similar to the client device 105 of FIG. 1.

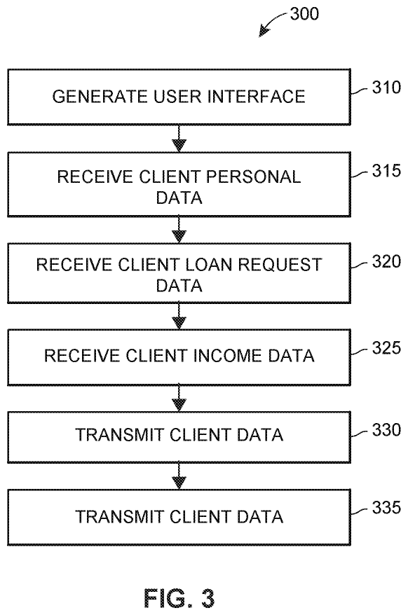

Turning to FIG. 3, a method of operation of a client device 300 may be implemented by a processor (e.g., processor 108 of FIG. 1) executing, for example, at least a portion of the modules 210-235 of FIG. 2 or the module 107 of FIG. 1. In particular, the processor 108 may execute a user interface generation module 210 to cause the processor 108 to, for example, generate a user interface (block 310). The user interface may enable a client to enter client information.

The processor 108 may execute a client personal information receiving module 215 to cause the processor 108 to, for example, receive client personal information from a client via, for example, the user interface (block 315). The processor 108 may execute a client loan request data receiving module 220 to cause the processor 108 to, for example, receive client loan request data from the client via, for example, the user interface (block 320). The processor 108 may execute a client income data receiving module 225 to cause the processor 108 to, for example, receive client income data from the client via, for example, the user interface (block 325). The processor 108 may execute a client data transmission module 230 to cause the processor 108 to, for example, transmit client data from the client device to any of a lender device 115, a government computing device 130, a real estate appraisal computing device 140, or a third-party computing device 150 (block 330). The processor 108 may execute a loan data receiving module 235 to cause the processor 108 to, for example, receive load data from, for example, a lender device 115 (block 335).

The client data may be, for example, representative of personal information (e.g., name, age, gender, address, social security number, marital status/spouse, employment/income, etc.) and/or income records (e.g., bank deposits, employer, self-employment contracts, paycheck subs, etc.). The client data may also be representative of home mortgage loan information related to purchase of real estate, such as, transaction detail (e.g., Purchase price, down payment amount, down payment percentage, loan amount), property detail (e.g., property address, how will property be used (e.g., primary residence, investment property, secondary/vacation home, etc.), type of home associated with the mortgage loan (e.g., single-family, two-family, three-family, four-family, condo, townhouse, etc.), state where the property associated with the loan located in, estimated real estate taxes associated with the property, estimated cost of homeowner's insurance, homeowner's association dues. The client data may be further representative of income and expense details (e.g., client's gross total income, client's current liabilities (e.g., credit cards, student loan, etc.), and/or whether the borrower is a FTHB and/or has not owned in the last 3 years).

The client data may be yet further representative of information associated with refinancing a home, obtaining a home equity loan, or obtaining a home equity line of credit, such as, refinance type (e.g., limited cash out, cash out, etc.), value of property being refinance (e.g., current market value, current loan balance, etc.), property detail, property address, how will property be used (e.g., primary residence, investment property, secondary/vacation home, etc.), what kind of home is being refinances (e.g., single-family, two-family, three-family, four-family, condo, townhouse, etc.), state where property being refinanced located, estimated real estate taxes associated with property being refinanced, estimated homeowner's insurance associated with property to be refinanced, and/or homeowner's association dues. The client data may also be representative of client income and expense details, such as, client gross total income, client current liabilities (e.g., credit cards, student loan, etc.), and/or whether the borrower is a first time home buyer (FTHB) or has not owned in the last 3 years.

The client data may also be representative of a vehicle loan (e.g., car, truck, recreational vehicle, all-terrain vehicle (ATV), boat, motorcycle, travel trailer, jet ski, snowmobile, hybrid vehicle, autonomous vehicle, etc.), including a purchase price, a cash rebate, a value of a trade-in, an amount owed on the trade-in, a down payment, a loan term (months), and/or an interest rate.

### Lender Device for Use in System for Determining Periodic Obligation Satisfactions Using Client Income Receipt Dates

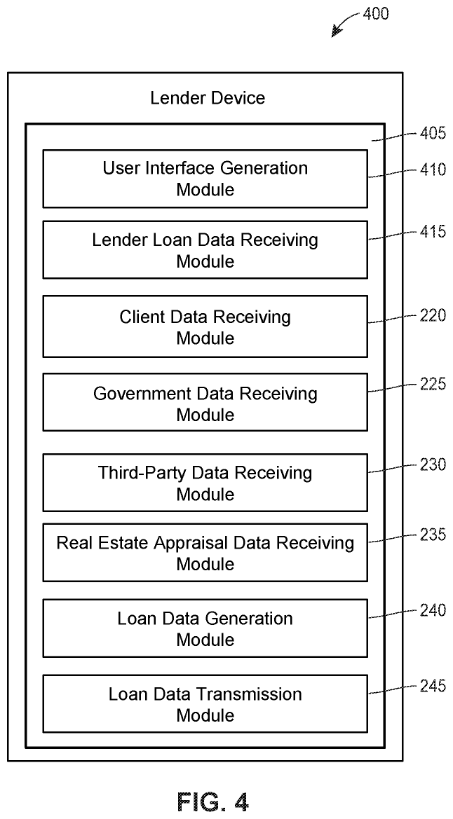

With reference to FIG. 4, a lender device 400 may include a user interface generation module 410, a lender loan data receiving module 415, a client data receiving module 420, a government data receiving module 425, a third-party data receiving module 430, a real estate appraisal data receiving module 435, a loan data generation module 440, and/or a loan data transmission module 445 stored on a memory 405. The lender device 400 may be similar to the lender device 115 of FIG. 1.

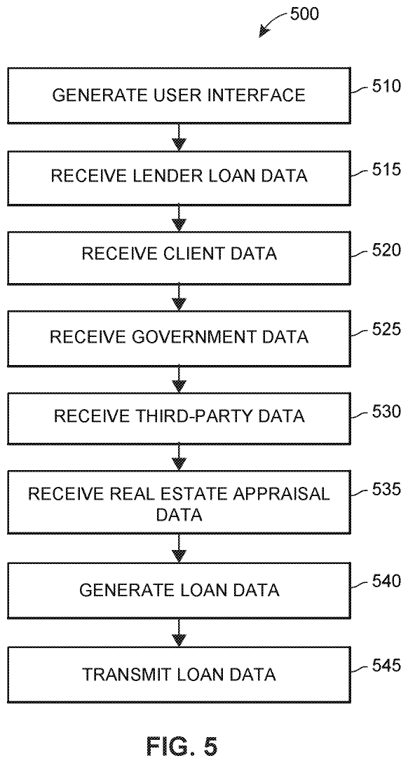

Turning to FIG. 5, a method of operation of a lender device 500 may be implemented by a processor (e.g., processor 118 of FIG. 1) executing, for example, at least a portion of the modules 410-445 of FIG. 4 or the module 117 of FIG. 1. In particular, the processor 118 may execute a user interface generation module 410 to cause the processor 118 to, for example, generate a user interface (block 510). The user interface may enable a lender to enter lender loan information.

The processor 118 may execute a lender loan data receiving module 415 to cause the processor 118 to, for example, receive lender loan information from a lender via, for example, the user interface (block 515). The processor 118 may execute a client data receiving module 420 to cause the processor 118 to, for example, receive client data from, for example, a client device 105, 200 (block 520). The processor 118 may execute a government data receiving module 425 to cause the processor 118 to, for example, receive government data from a government device 130, 600 (block 525). The processor 118 may execute a third-party data receiving module 430 to cause the processor 118 to, for example, receive third-party data from a third-party computing device 150, 1000 (block 530). The processor 118 may execute a real estate appraisal data receiving module 435 to cause the processor 118 to, for example, receive real estate appraisal data from a real estate appraisal computing device 140, 800 (block 535).

The processor 118 may execute a loan data generation module 440 to cause the processor 118 to, for example, generate loan data (block 540). The loan data may be based upon, for example, client data, client income amount data, client income receipt date data, lender data, government data, real estate appraisal data, insurance cost data, warranty cost data, and/or third-party data. The loan data may be dynamically determined based on client predicted (e.g., future) income data (e.g., client future income amounts and/or client future income receipt dates). The loan data may be representative of a client obligation satisfactions (e.g., loan payments, warranty payments, insurance payments, any combination thereof, any sub-combination thereof, etc.) schedule that is representative of payment due dates that are correlated with client income receipt dates. The processor 118 may execute a loan data transmission module 445 to cause the processor 118 to, for example, transmit loan data from the lender device to any of a client device 105, 200, a government computing device 130, 600, a real estate appraisal computing device 140, 800, or a third-party computing device 150, 1000 (block 545).

The lender data may also be representative of home mortgage loan information related to purchase of real estate, such as, transaction detail (e.g., Purchase price, down payment amount, down payment percentage, loan amount), property detail (e.g., property address, how will property be used (e.g., primary residence, investment property, secondary/vacation home, etc.), type of home associated with the mortgage loan (e.g., single-family, two-family, three-family, four-family, condo, townhouse, etc.)), state where the property associated with the loan located in, estimated real estate taxes associated with the property, estimated cost of homeowner's insurance, homeowner's association dues. The lender data may be further representative of income and expense details (e.g., client's gross total income, client's current liabilities (e.g., credit cards, student loan, etc.), and whether the borrower is a FTHB or has not owned in the last 3 years.

The lender data may be yet further representative of information associated with refinance a home, obtaining a home equity loan, or obtaining a home equity line of credit, such as, refinance type (e.g., limited cash out, cash out, etc.), value of property being refinanced (e.g., current market value, current loan balance, etc.), property detail, property address, how will property be used (e.g., primary residence, investment property, secondary/vacation home, etc.), what kind of home is being refinances (e.g., single-family, two-family, three-family, four-family, condo, townhouse, etc.), state where property being refinanced located, estimated real estate taxes associated with property being refinanced, estimated homeowner's insurance associated with property to be refinanced, and/or homeowner's association dues. The lender data may also be representative of client income and expense details, such as, client gross total income, client current liabilities (e.g., credit cards, student loan, etc.), and/or whether borrower a FTHB/not owned in the last 3 years.

The lender data may also be representative of a vehicle loan (e.g., car, truck, recreational vehicle, all-terrain vehicle (ATV), boat, motorcycle, travel trailer, jet ski, snowmobile, etc.), including a purchase price, a cash rebate, a value of a trade-in, an amount owed on the trade-in, a down payment, a loan term (months), and/or an interest rate.

Government Computing Device for Use within a System for Determining Periodic Obligation Satisfactions Based Upon Client Income Receipt Dates

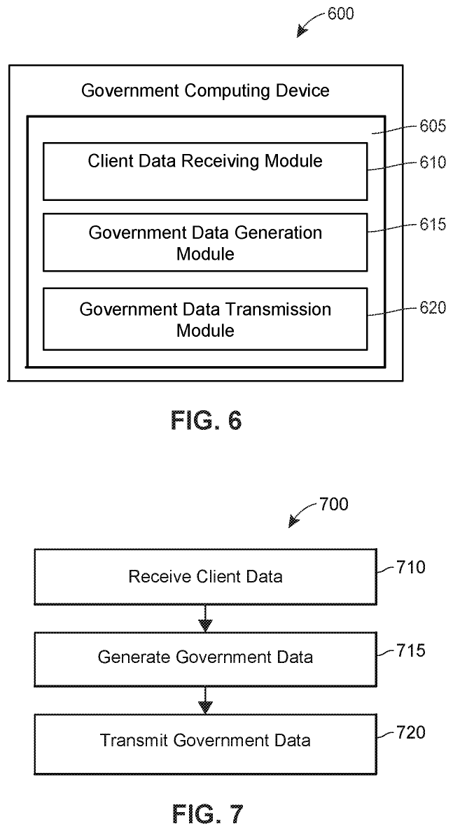

With reference to FIG. 6, a government computing device 600 may include a client data receiving module 610, a government data generation module 615, and a government data transmission module 620 stored on a memory 605. The government computing device 600 may be similar to the government computing device 130 of FIG. 1.

Turning to FIG. 7, a method of operation of a government computing device 700 may be implemented by a processor (e.g., processor 133 of FIG. 1) executing, for example, at least a portion of the modules 610-620 of FIG. 6 or the module 132 of FIG. 1. In particular, the processor 133 may execute a client data receiving module 610 to cause the processor 133 to, for example, receive client data (e.g., client personal information, real estate information, vehicle information, etc.) from a client device 105, 200 (block 710).

The processor 133 may execute a government data generation module 615 to cause the processor 133 to, for example, generate government data based upon, for example, the client data and data stored in a government related database 134 (block 715). The processor 133 may execute a government data transmission module 620 to cause the processor 133 to, for example, transmit government data from the government computing device to any of a client device 105, 200, a lender device 115, 400, a real estate appraisal computing device 140, 800, or a third-party computing device 150, 1000 (block 720).

The government data may be representative of client criminal records (e.g., LexisNexis report, truthfinder.com, instantcheckmate.com, backgroundalert.com, screeningworks.com, local municipality, County, State, Federal, etc.) information, bureau of motor vehicle (BMV) driving records (e.g., client accidents, client vehicle insurance information, etc.) information, and/or real estate records (e.g., County Auditor's Office, Department of Natural Resources, etc.).

Real Estate Appraisal Computing Device for Use within a System for Determining Periodic Obligation Satisfactions Based Upon Client Income Receipt Dates

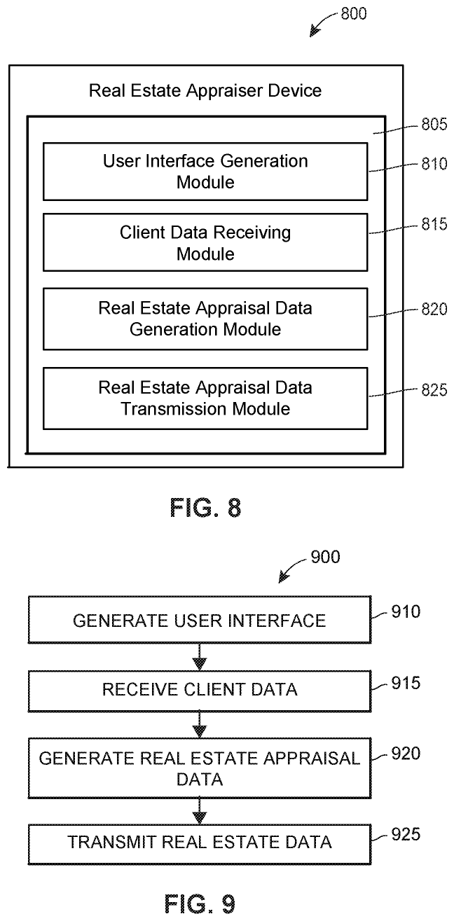

With reference to FIG. 8, a real estate appraisal computing device 800 may include a user interface generation module 810, a client data receiving module 815, a real estate appraisal data generation module 820, and/or a real estate data transmission module 825 stored on a memory 805. The real estate appraisal computing device 800 may be similar to the real estate appraisal computing device 140 of FIG. 1.

Turning to FIG. 9, a method of operation of a real estate appraisal computing device 900 may be implemented by a processor (e.g., processor 143 of FIG. 1) executing, for example, at least a portion of the modules 810-825 of FIG. 8 or the module 142 of FIG. 1. In particular, the processor 143 may execute a user interface generation module 810 to cause the processor 143 to, for example, generate a user interface (block 910). The user interface may enable a real estate appraiser to enter real estate appraisal information (e.g., an appraised value of real estate).

The processor 143 may execute a client data receiving module 815 to cause the processor 143 to, for example, receive client data from a client device 105, 200 (block 915). The processor 143 may execute a real estate appraisal data generation module 820 to cause the processor 143 to, for example, generate real estate appraisal data based upon, for example, the client data and data stored in a real estate appraisal related database 144 (block 920). The processor 143 may execute a real estate appraisal data transmission module 825 to cause the processor 143 to, for example, transmit real estate appraisal data from the real estate appraisal computing device 140, 800 to any of a client device 105, 200, a lender device 115, 400, a government computing device 130, 600, or a third-party computing device 150, 1000 (block 925). The real estate appraisal data may be representative of, for example, an appraised value of real estate, physical condition of real estate, leans placed on real estate, etc.

Third-Party Computing Device for Use within a System for Determining Periodic Obligation Satisfactions Based Upon Client Income Receipt Dates

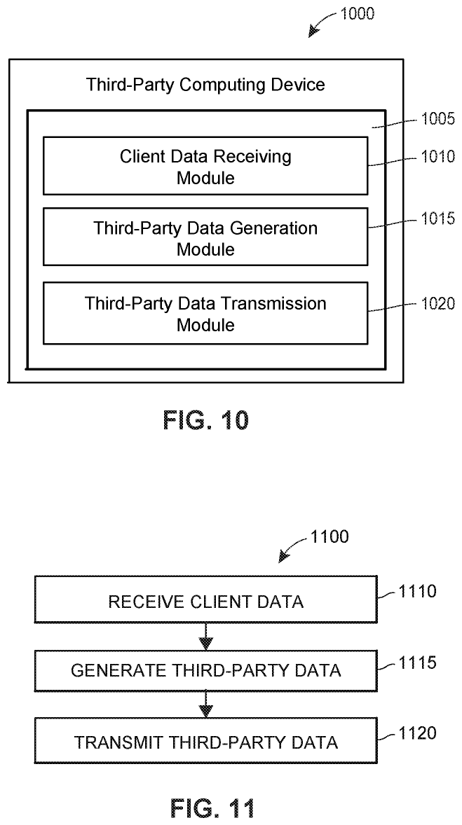

With reference to FIG. 10, a third-party computing device 1000 may include a client data receiving module 1010, a third-party data generation module 1015, and a third-party data transmission module 1020 stored on a memory 1005. The third-party computing device 1000 may be similar to the third-party computing device 150 of FIG. 1.

Turning to FIG. 11, a method of operation of the third-party computing device 1100 may be implemented by a processor (e.g., processor 153 of FIG. 1) executing, for example, at least a portion of the modules 1010-1020 of FIG. 10 or the module 152 of FIG. 1. In particular, the processor 153 may execute a client data receiving module 1010 to cause the processor 153 to, for example, receive client data (e.g., client personal information, real estate information, vehicle information, etc.) from a client device 105, 200 (block 1110).

The processor 153 may execute a third-party data generation module 1015 to cause the processor 153 to, for example, generate third-party data based upon, for example, the client data and data stored in a third-party related database 154 (block 1115). The processor 153 may execute a third-party data transmission module 1020 to cause the processor 153 to, for example, transmit third-party data from the third-party computing device to any of a client device 105, 200, a lender device 115, 400, a government computing device 130, 600, or a real estate appraisal computing device 140, 600 (block 1120).

The third-party data may be representative of income records (e.g., bank deposits, employer, self-employment contracts, paycheck stubs, etc.), financial institution (e.g., bank, credit union, brokerage firm, annuity firm, etc.) information, life insurance, and/or payment history. The third-party data may also be representative of credit rating agencies (e.g., VantageScore, Experian, TransUnion, Equifax, etc.) information (e.g., credit score, credit card debt, credit card limits, and/or credit card monthly balance cycle. The third-party data may further be representative of existing loans (e.g., loan holder, amount of loan, when pay off due, payment history, etc.), assets (e.g., real estate, vehicles, savings accounts, stocks, annuities, bonds, etc.), current/past insurance (e.g., LexisNexis report, truthfinder.com, instantcheckmate.com, backgroundalert.com, screeningworks.com, real estate records, vehicle records, life insurance records, health insurance records, dental insurance records, vision insurance records, etc.), a vehicle value (e.g., Kelley Blue Book, NADA Guides, Edmunds, etc.), vehicle maintenance records (e.g., carfax, vehicle original equipment manufacturer, etc.), and/or client income records (e.g., bank deposits, employer, self-employment contracts, paycheck subs, etc.).

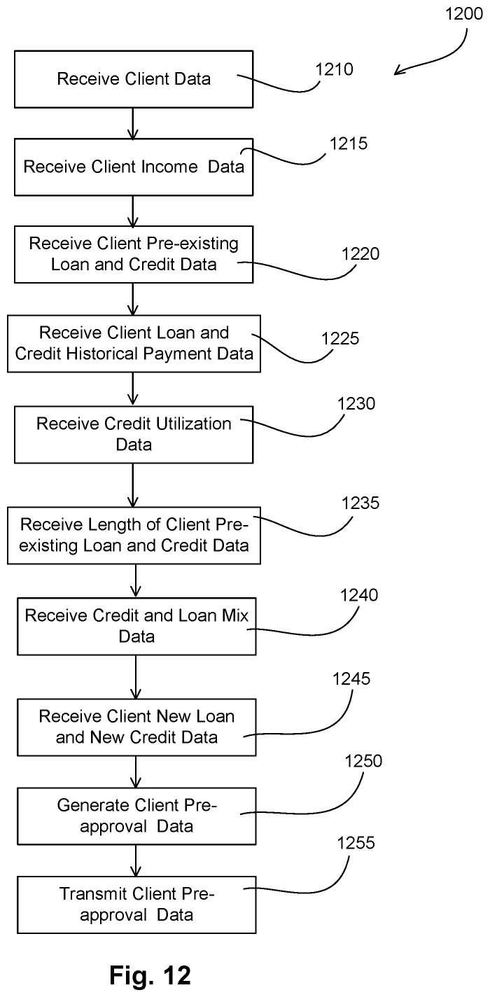

With reference to FIG. 12, an exemplary computer-implemented method of determining whether an individual is suitable for enrollment for periodic obligation satisfaction 1200 may be implemented by a processor (e.g., processor 153 of FIG. 1) executing, for example, at least a portion of the modules 1010-1020 of FIG. 10 or the module 152 of FIG. 1. In particular, the processor 153 may execute a client data receiving module 1010 to cause the processor 153 to, for example, receive client data (e.g., client identification information, client social security number information, etc.) from a client device 105, 200 (block 1210).

The processor 153 may execute a third-party data receiving module 1010 to cause the processor 153 to, for example, receive client income data (block 1215). The client income data may be, for example, representative of a client past income amount, a client past income receipt date, a client current income amount, a client current income receipt date, a client future income amount, a client future income receipt date, any one thereof, or any combination thereof.

The processor 153 may execute a third-party data receiving module 1010 to cause the processor 153 to, for example, receive client pre-existing loan and credit data (block 1220). The client pre-existing loan and credit data may be representative of, for example, current client loans and/or current client available credit.

The processor 153 may execute a third-party data receiving module 1010 to cause the processor 153 to, for example, receive client loan and credit historical payment data (block 1225). Client loan and credit historical payment data may, for example, reflect thirty-five percent of a total client suitability for enrollment for periodic obligation satisfaction. The client loan and credit historical payment data may be based upon, for example, a borrower's payment history. Client loan and credit historical payment data may be used, for example, to forecast future long-term client repayment behavior. Client loan and credit historical payment data may reflect both revolving loan payments (e.g., credit cards, home equity line of credit, etc.) and installment loan payments (e.g., mortgages, vehicle loans, student loans, etc.). Although a weight of each loan may vary when determining whether an individual is suitable for enrollment for periodic obligation satisfaction, defaulting on a larger installment loan (e.g., a mortgage) may lower a suitability of an individual more severely than defaulting on a smaller revolving loan.

The processor 153 may execute a third-party data receiving module 1010 to cause the processor 153 to, for example, receive credit utilization data (block 1230). The credit utilization data may, for example, reflect thirty percent of a total client suitability for enrollment for periodic obligation satisfaction. Credit utilization data may be based upon, for example, a credit utilization of a client (e.g., a percentage of available credit that has been borrowed on a credit card, a percentage of available credit that has been borrowed on a home equity line of credit, etc.). A client who habitually maxes out credit cards, or who gets very close to their credit limits, may be, for example, indicative of a person who are not suitable for enrollment for periodic obligation satisfaction. A client that is more suitable for enrollment for periodic obligation satisfaction may, for example, average approximately a seven percent credit utilization ratio. However, a ten to twenty percent usage may be acceptable. These percentages may apply to each individual client credit card, as well as, an overall level of client debt.

The processor 153 may execute a third-party data receiving module 1010 to cause the processor 153 to, for example, receive length of client pre-existing loan and credit data (block 1235). The length of credit history data may reflect, for example, fifteen percent of a total client suitability for enrollment for periodic obligation satisfaction. The length of credit history data may be based upon, for example, a length of time each account has been open and the length of time since the account's most recent action. A longer client credit history may provide more information and may offer a better picture of long-term financial behavior. Therefore, a client with a longer credit history may be determined to be more suitable for enrollment for periodic obligation satisfaction compared to a client with a relatively shorter credit history.

The processor 153 may execute a third-party data receiving module 1010 to cause the processor 153 to, for example, receive credit and loan mix data (block 1240). The credit and loan mix data may be representative of a mixture of client loans and client credit. Repaying a variety of debt may indicate that a client may handle all sorts of credit and, therefore, may be more suitable for enrollment for periodic obligation satisfaction compared to a client with a different mixture of loans and credit. A client with a mixture of revolving credit and installment loans may generally be more suitable for enrollment for periodic obligation satisfaction.

The processor 153 may execute a third-party data receiving module 1010 to cause the processor 153 to, for example, receive client new loan and new credit data (block 1245). The client new loan and new credit data may be representative of a new loan and/or a new line of credit that a client has entered into subsequent to a prior determination as to whether the client is suitable for enrollment for periodic obligation satisfaction. A client that opens several new loans or new lines of credit may be less suitable for enrollment for periodic obligation satisfaction compared to a client that opens relatively fewer new loans or new lines of credit.

The processor 153 may execute a third-party data generation module 1015 to cause the processor 153 to, for example, generate client pre-approval data based upon, for example, the client data, the client income data, the client loan and credit historical payment data, the credit utilization data, the length of client pre-existing loan and credit data, the credit and loan mix data, the client new loan and new credit data, any one thereof, any sub-combination thereof, or any combination thereof (block 1250). The client pre-approval data may be representative of, for example, whether an individual is suitable for enrollment for periodic obligation satisfaction.

The processor 153 may execute a third-party data transmission module 1020 to cause the processor 153 to, for example, transmit the client pre-approval data from the third-party computing device to any of a client device 105, 200, a lender device 115, 400, a government computing device 130, 600, or a real estate appraisal computing device 140, 600 (block 1255).

### Technical Advantages

The aspects described herein may be implemented as part of one or more computer components (such as a client device) and/or one or more back-end components (such as a lender device), for example. Furthermore, the aspects described herein may be implemented as part of a computer network architecture and/or a computing architecture that facilitates communications between various other devices and/or components. Thus, the aspects described herein address and solve issues of a technical nature that are necessarily rooted in computer technology.

For instance, some aspects include analyzing various sources of data to determine obligation satisfactions (e.g., loan payments, warranty payments, insurance payments, any combination thereof, any sub-combination thereof, etc.) based upon client income receipt dates. Once this is determined, the aspects may also allow for a determination of whether the client income receipt dates have changed. In doing so, the aspects may overcome issues associated with the inconvenience of manual and/or unnecessary funds transfers. Without the improvements suggested herein, additional processing and memory usage may be required to perform such transfers, as a client device may need to download additional data and process this data as part of the obligation satisfaction (e.g., loan payments, warranty payments, insurance payments, any combination thereof, any sub-combination thereof, etc.) process.

Furthermore, the embodiments described herein may function to optimize a loan payment schedule based upon client income receipt dates. The process may improve upon existing technologies by more accurately forecasting a user's account balance using additional data sources. Due to this increase in accuracy, the aspects may address computer-related issues regarding efficiency over the traditional amount of processing power and models used to set loan payments. Thus, the aspects may also address computer related issues that are related to efficiency metrics, such as consuming less power, for example.

### Additional Embodiments

The present embodiments may relate to dynamically adjusting a flexible loan product. For instance, conventional loan products may work fine for those customers with steady or periodic paychecks. However, others work on commission or have seasonal work, and thus may have uneven or seasonal changes in the amount they are getting paid. A flexible loan product may be provided that varies the timing and/or amount of a minimum payment. As an example, those with seasonal work, may have all or most of their minimum payments due during the months that they have seasonal work (such as winter or summer). The flexible loan product may allow the customer to choose when, such as which months, that they would like to pay back the loan, i.e., make loan payments. The flexible loan product may allow the customer, if they over pay the current amount that is due, to either pay down more principal, or pre-pay next year's loan payments.

In one aspect, machine learning algorithms or artificial intelligence may be employed to estimate a current year's income based upon one or more previous year's income. The historical income may be used to project current pay, and an amount that the customer can afford to pay each month. In this manner, variable or seasonal income may be accounted for. Some monthly payments may be eliminated entirely, or be reduced to a partial payments (e.g., reduce $300 payment to $100 for certain months).

In other aspects, a bundle loan product may be provided. For instance, for a home loan, home insurance and one or more warranties may be included in the loan product. For a vehicle loan, vehicle insurance and one or more warranties may be included in the loan product.

In one embodiment, an obligation satisfaction computer system configured to dynamically adjust a flexible loan product to account for and/or based upon uneven or seasonal income of a client may be provided. The computer system may include (1) a client income data receiving module stored on a memory that, when executed by a processor, causes the processor to receive client income data, wherein the client income data is representative of client income amounts and client income receipt dates; and (2) a client obligation satisfaction generation module stored on a memory that, when executed by a processor, causes the processor to generate a client obligation satisfaction schedule based upon the client income data, wherein the client obligation satisfaction schedule is representative of payment due dates that are correlated with the client income receipt dates to facilitate loan repayment flexibility for client's with uneven pay or income.

### Additional Considerations

This detailed description is to be construed as exemplary only and does not describe every possible embodiment, as describing every possible embodiment would be impractical, if not impossible. One may implement numerous alternate embodiments, using either current technology or technology developed after the filing date of this application.

Further to this point, although some embodiments described herein utilize sensitive information (e.g., personal identification information, credit information, income information, etc.), the embodiments described herein are not limited to such examples. Instead, the embodiments described herein may be implemented in any suitable environment in which it is desirable to identify and control specific type of information. For example, the aforementioned embodiments may be implemented by a financial institution to identify and contain bank account statements, brokerage account statements, tax documents, etc. To provide another example, the aforementioned embodiments may be implemented by a lender to not only identify, re-route, and quarantine credit report information, but to apply similar techniques to prevent the dissemination of loan application documents that are preferably delivered to a client for signature in accordance with a more secure means (e.g., via a secure login to a web server) than via email.

Furthermore, although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software), may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of some of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

1. An obligation satisfaction system, the system comprising:
a user interface generation module stored on a memory of a client device that, when executed by a processor of the client device, causes the processor of the client device to generate a user interface on a display device of the client device, wherein the user interface enables an individual to enter client personal information data and client loan request data;
a client obligation satisfaction generation module stored on a memory of a remote device that, when executed by a processor of the remote device in response to the individual entering client personal information data and client loan request data via the user interface of the client device, causes the processor of the remote device to receive the client personal information data from the client device and, in response to receiving the client personal information data and client loan request data from the client device, receive variable client income data and at least one of: client loan and credit historical payment data, credit utilization data, length of client pre-existing loan and credit data, credit and loan mix data, or client new loan and new credit data from a third-party database, and, in response to receiving the variable client income data and the at least one of: the client loan and credit historical payment data, the credit utilization data, the length of client pre-existing loan and credit data, the credit and loan mix data, or the client new loan and new credit data from the third-party database, dynamically generate client obligation satisfaction schedule data based upon the variable client income data and the at least one of: the client loan and credit historical payment data, the credit utilization data, the length of client pre-existing loan and credit data, the credit and loan mix data, or the client new loan and new credit data, wherein the client obligation satisfaction schedule data is representative of at least one of: dynamically determined payment amounts that are correlated with client income receipt dates, dynamically determined client loan and insurance payments that are correlated with client income receipt dates, or dynamically determined payment due dates that are correlated with client income receipt dates; and
further execution of the user interface generation module by the processor of the client device, causes the processor of the client device to receive the client obligation satisfaction schedule data from the remote device and, in response to receiving the client obligation satisfaction schedule data from the remote device, generate a user interface display based on the client obligation satisfaction schedule data, wherein the user interface display allows a client to pay down more principal, or pre-pay next year's loan payments.

2. The system of claim 1, wherein the client personal information data is representative of at least one of: client identification information or client social security number information.

3. The system of claim 1, wherein the client historical income data is representative of at least one of: a client past income amount, a client past income receipt date, a client current income amount, or a client current income receipt date, and wherein the variable client income data is representative of at least one of: a client future income amount or a client future income receipt date.

4. The system of claim 1, wherein the client pre-existing loan and credit data is representative of at least one of: a current client loan or a current client available credit.

5. The system of claim 1, wherein the client loan and credit historical payment data reflects thirty-five percent of a total client suitability for enrollment for periodic obligation satisfaction, wherein the client loan and credit historical payment data is based upon a borrower's payment history, wherein the client loan and credit historical payment data is used to forecast future long-term client repayment behavior, and wherein the client loan and credit historical payment data reflects at least one of: revolving loan payments or installment loan payments.

6. The system of claim 5, wherein revolving loan payments include at least one of: a credit card payment, or a home equity line of credit payment, and wherein installment loan payments include at least one of: a mortgage payment, a vehicle loan payment, or a student loan payment.

7. The system of claim 5, wherein a weight of each loan varies when determining whether an individual is suitable for enrollment for periodic obligation satisfaction, and wherein defaulting on an installment loan for a first amount of money has a first weight and defaulting on a revolving loan for a second amount of money has a second weight, wherein the first amount of money is greater than the second amount of money, and wherein the first weight is higher than the second weight.

8. A tangible computer-readable medium including computer-readable instructions stored thereon that, when executed by at least one processor, cause the at least one processor to implement an obligation satisfaction system, the tangible computer-readable medium comprising:
a user interface generation module that, when executed by a processor of a client device, causes the processor of the client device to generate a user interface on a display device of the client device, wherein the user interface enables an individual to enter client personal information data and client loan request data;
a client obligation satisfaction generation module that, when executed by a processor of a remote device in response to the individual entering client personal information data and client loan request data via the user interface of the client device, causes the processor of the remote device to receive the client personal information data from the client device and, in response to receiving the client personal information data and client loan request data from the client device, receive variable client income data and at least one of: client loan and credit historical payment data, credit utilization data, length of client pre-existing loan and credit data, credit and loan mix data, or client new loan and new credit data from a third-party database, and, in response to receiving the variable client income data and the at least one of: the client loan and credit historical payment data, the credit utilization data, the length of client pre-existing loan and credit data, the credit and loan mix data, or the client new loan and new credit data from the third-party database, dynamically generate client obligation satisfaction schedule data based upon the variable client income data and the at least one of: the client loan and credit historical payment data, the credit utilization data, the length of client pre-existing loan and credit data, the credit and loan mix data, or the client new loan and new credit data, wherein the client obligation satisfaction schedule data is representative of at least one of: dynamically determined payment amounts that are correlated with client income receipt dates, dynamically determined client loan and insurance payments that are correlated with client income receipt dates, or dynamically determined payment due dates that are correlated with client income receipt dates; and
further execution of the user interface generation module by the processor of the client device, causes the processor of the client device to receive the client obligation satisfaction schedule data from the remote device and, in response to receiving the client obligation satisfaction schedule data from the remote device, generate a user interface display based on the client obligation satisfaction schedule data, wherein the user interface display allows a client to pay down more principal, or pre-pay next year's loan payments.

9. The tangible computer-readable medium of claim 8, further comprising:
a third-party data receiving module that, when executed by a processor, causes the processor to receive credit utilization data, wherein the credit utilization data reflects thirty percent of a total client suitability for enrollment for periodic obligation satisfaction, wherein the credit utilization data is based upon a credit utilization of a client that is selected from the group including: a percentage of available credit that has been borrowed on a credit card or a percentage of available credit that has been borrowed on a home equity line of credit.

10. The tangible computer-readable medium of claim 9, wherein a client that maxes out credit cards, or that gets close to a credit limit, is indicative of a client who is not suitable for enrollment for periodic obligation satisfaction.

11. The tangible computer-readable medium of claim 9, wherein a ten to twenty percent credit usage is acceptable, and wherein percentages apply to each individual client credit card, or an overall level of client debt.

12. The tangible computer-readable medium of claim 8, further comprising:
a third-party data receiving module that, when executed by a processor, causes the processor to receive length of client pre-existing loan and credit data, wherein the length of credit history data reflects fifteen percent of a total client suitability for enrollment for periodic obligation satisfaction, and wherein the length of credit history data is based upon at least one of: a length of time each account has been open or a length of time since the account's most recent action.

13. The tangible computer-readable medium of claim 12, wherein a longer client credit history is indicative of client long-term financial behavior.

14. The tangible computer-readable medium of claim 12, wherein a first client with a first number of years of credit history has a first suitability for enrollment for periodic obligation satisfaction, wherein a second client with a second number of years of credit history has a second suitability for enrollment for periodic obligation satisfaction, wherein the first number of years of credit history is more than the second number of years of credit history, and wherein the first suitability for enrollment for periodic obligation satisfaction is indicative of a higher suitability for enrollment for periodic obligation satisfaction compared to the second suitability for enrollment for periodic obligation satisfaction.

15. A computer-implemented obligation satisfaction method, the method comprising:
generating, using a processor of a client device, a user interface on a display device of the client device in response to the processor of the client device executing a user interface generation module, wherein the user interface enables an individual to enter client personal information data and client loan request data;
receiving, using a processor of a third-party computing device in response to the individual entering client personal information data and client loan request data via the user interface of the client device, the client personal information data and at least one of: client historical income data, client loan and credit historical payment data, credit utilization data, length of client pre-existing loan and credit data, credit and loan mix data, or client new loan and new credit data based on the client personal information data, from a third-party database;
generating, using the processor of the third-party computing device in response to receiving the client personal information data and the at least one of: client historical income data, client loan and credit historical payment data, credit utilization data, length of client pre-existing loan and credit data, credit and loan mix data, or client new loan and new credit data based on the client personal information data, from a third-party database, client pre-approval data that is based upon at least one of: the client historical income data, the client loan and credit historical payment data, the credit utilization data, the length of client pre-existing loan and credit data, the credit and loan mix data, or the client new loan and new credit data, wherein the client pre-approval data is representative of whether the individual is suitable for enrollment for periodic obligation satisfaction;
receiving variable client income data and the client pre-approval data from the third-party device in response to the third-party device generating the client pre-approval data;
dynamically generating, using a processor of a lender computing device in response to receiving the variable client income data and the client pre-approval data from the third-party device, client obligation satisfaction schedule data based upon the variable client income data and the client pre-approval data, wherein the client obligation satisfaction schedule data is representative of at least one of: dynamically determined payment amounts that are correlated with variable client income receipt dates, dynamically determined client loan and insurance payments that are correlated with variable client income receipt dates, or dynamically determined payment due dates that are correlated with variable client income receipt dates;
transmitting, using the processor of the lender computing, the client obligation satisfaction schedule data to the client device in response to the processor of the lender computing device generating the client obligation satisfaction schedule data; and
generating a user interface display, using the processor of the client computing device in response to receiving the client obligation satisfaction schedule data from the lender computing device, based on the client obligation satisfaction schedule data, in response to the processor of the client computing device further executing the user interface generation module, wherein the user interface display allows a client to pay down more principal, or pre-pay next year's loan payments.

16. The method of claim 15, further comprising:
receiving, at a processor of a computing device, credit and loan mix data, wherein the credit and loan mix data is representative of a mixture of client loans and client credit.

17. The method of claim 16, wherein repaying a variety of debt indicates that a client handles all sorts of credit.

18. The method of claim 16, wherein a first client with first revolving credit and first installment loans has a first suitability for enrollment for periodic obligation satisfaction, wherein a second client with second revolving credit and second installment loans has a second suitability for enrollment for periodic obligation satisfaction, and wherein the first suitability is different than the second suitability.

19. The method of claim 15, further comprising:
receiving, at a processor of a computing device, client new loan and new credit data, wherein the client new loan and new credit data is representative of at least one of: a new loan that a client has entered into subsequent to a prior determination as to whether the client is suitable for enrollment for periodic obligation satisfaction, or a new line of credit that a client has entered into subsequent to a prior determination as to whether the client is suitable for enrollment for periodic obligation satisfaction.

20. The method of claim 19, wherein a first client opens a first number of new loans or a first number of new lines of credit, wherein a second client opens a second number of new loans or a second number of new lines of credit, wherein the first number is larger than the second number, wherein the first client has a first suitability for enrollment for periodic obligation satisfaction, wherein the second client has a second suitability for enrollment for periodic obligation satisfaction, and wherein the first suitability is less than the second suitability.
